(19) United States
(12) Patent Application Publication
(10) Pub. No.: US 2023/0297744 A1
(43) Pub. Date: Sep. 21, 2023

(54) SYSTEMS AND METHODS FOR AI/ML BASED DIGITAL TWIN FOR POWER SYSTEM

(71) Applicant: OPERATION TECHNOLOGY, INC., Irvine, CA (US)

(72) Inventors: Tanuj Khandelwal, Irvine, CA (US); Ahmed Saber, Irvine, CA (US); Shaikh Sahid Hossain, Irvine, CA (US)

(21) Appl. No.: 18/108,600

(22) Filed: Feb. 11, 2023

Related U.S. Application Data
(60) Provisional application No. 63/309,443, filed on Feb. 11, 2022.

(51) Int. Cl. G06F 30/27; G06F 30/367

(52) U.S. Cl. CPC G06F 30/27; G06F 30/367; G06F 2119/02

(57) ABSTRACT

Some embodiments relate to systems and methods for analyzing an electrical network. For example, a system for analyzing an electrical network may include a memory and a processor, coupled to the memory. The processor is configured to execute instructions from the memory causing the processor to: perform power system studies to improve system reliability and security using historical data of past power system operations, derive a data model of the power system using artificial intelligence, and using the data model and training with the power system analysis data to conduct analyses for predicting at least one of system behavior and forecasting applications, and report the at least one of system behavior and forecasting applications.

### CLAIM OF PRIORITY UNDER 35 U.S.C. § 119

The present Application for Patent claims priority to Provisional Application No. 63/309,367 entitled “SYSTEMS AND METHODS FOR AI/ML BASED DIGITAL TWIN FOR POWER SYSTEM” filed Feb. 11, 2022, and assigned to the assignee hereof and hereby expressly incorporated by reference herein.

### TECHNICAL FIELD

The disclosure relates generally to the field of power, specifically and not by way of limitation, some embodiments are related to applying artificial intelligence to power systems.

### BACKGROUND OF THE INVENTION

The electrical network can be developed using the automation approach with various current data available with de-centralized technologies and platforms such as ADMS, GIS, MDM, OSI-PI, etc. to integrate and automate the software electrical network model development platform to perform power system studies to improve system reliability and security.

### SUMMARY

In one example implementation, an embodiment includes systems and methods for electrical networks that can be developed using the automation approach with various current data available with de-centralized technologies and platforms such as ADMS, GIS, MDM, OSI-PI etc. to integrate and automate the software electrical network model development platform to perform power system studies to improve system reliability and security.

Some embodiments relate to systems and methods for analyzing an electrical network. For example, a system for analyzing an electrical network may include a memory and a processor, coupled to the memory. The processor is configured to execute instructions from the memory causing the processor to perform power system studies to improve system reliability and security using historical data of past power system operations, derive a data model of the power system using artificial intelligence, and using the data model and training with the power system analysis data to conduct analyses for predicting at least one of system behavior and forecasting applications, and report the at least one of system behavior and forecasting applications.

Some embodiments relate to systems and methods for analyzing an electrical network. For example, a method for analyzing an electrical network, may include performing power system studies to improve system reliability and security using historical data of past power system operations, deriving a data model of the power system using artificial intelligence, using the data model and training with the power system analysis data to conduct analyses for predicting at least one of system behavior and forecasting applications, and reporting the at least one of system behavior and forecasting applications.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The present invention may be better understood by referring to the following figures. The components in the figures are not necessarily to scale. Emphasis instead being placed upon illustrating the principles of the disclosure. In the figures, reference numerals designate corresponding parts throughout the different views.

FIG. 1 is a block diagram illustrating an example of data preparation, data pre-processing, and model training and processing in accordance with the systems and methods described herein.

FIGS. 2A-2C form a block diagram illustrating a general workflow in accordance with the systems and methods described herein.

FIGS. 2A-2C form a block diagram illustrating a general workflow in accordance with the systems and methods described herein. Several examples use cases are now discussed. The first use case includes electricity loss. FIG. 3 is a block diagram illustrating a use case including electricity loss in accordance with the systems and methods described herein.

FIG. 3 is a block diagram illustrating a use case including electricity loss in accordance with the systems and methods described herein.

FIG. 4 is a block diagram illustrating a use case of intrusion detection in accordance with the systems and methods described herein.

FIG. 5 is a block diagram illustrating a use case including a customer meter anomaly in accordance with the systems and methods described herein.

FIG. 6 is a diagram illustrating a scripting example in accordance with the systems and methods described herein.

FIG. 7 is a flow diagram illustrating an example method in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of power systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

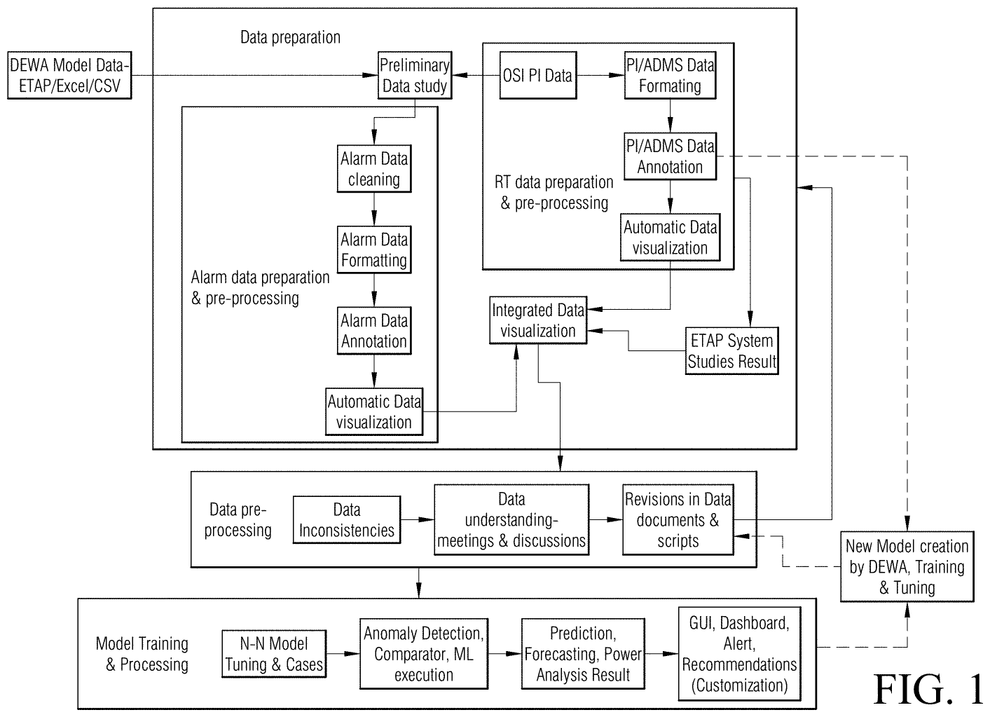

FIG. 1 is a block diagram illustrating an example of data preparation, data pre-processing, and model training and processing in accordance with the systems and methods described herein.

In some example embodiments, AI/ML requirements and challenges may include one or more of conducting 100s of scenarios with load and generation variation is tedious through manual process, finding the best conditions of operational network, prediction of the system anomaly, using a deep-encoder model for forecasting, performing network reduction, performing a security assessment, performing grid code management, and/or predict and alert the system behavior and detect the anomalies of the power system analysis results.

As discussed above, the electrical network can be developed using the automation approach with various current data available with de-centralized technologies and platforms such as ADMS, GIS, MDM, OSI-PI etc. to integrate and automate the software electrical network model development platform to perform power system studies to improve system reliability and security.

Additionally, using the historical data of past operational data, the data model can be derived for conducting AWL-based deep-encoders and finding the anomalies. These data models can be further be trained with the power system analysis data to conduct various analyses for predicting the system behavior and forecast applications. The centralized model represents the digital twin model of the electrical network. The same can be achieved through: bring the power of software library and advance technology to complete the missing data, validation and enhancement of the converted model with load flow and dynamic analysis to provide an accurate real-time operations analysis model by conducting the simulation using real-time measurement and network topology, additionally, network model management (addition, deletion, change model updating) through automated cloud-based network model management application for model integrity, the hybrid data model may be created from the real-time data as well as various structured variables. One or more of two sets of AI/ML may be created: Data anomaly and pattern detection to provide the data anomaly, and/or Analyzing the power system simulation results as well as conducting the deep model development to conduct varieties of analysis by changing the loading and generation pattern for 1000's of scenarios and cases.

Subsequently the historical data may be analyzed for machine learning model creation for situational intelligence through deep learning to answer the following questions: (1) Descriptive: What has happened? (2) Predictive: What could happen? (3) Prescriptive: Best outcome? (4) Cognitive: Dynamic learning

The overall platform-based approach is envisioned to connect, optimize, and scale your digital industrial applications. IT and OT data may comprise SCADA, PMU, AMI, EMS, Simulation Results, Market, IED, Billing, Weather, etc. This big data supports the whole process of the power system.

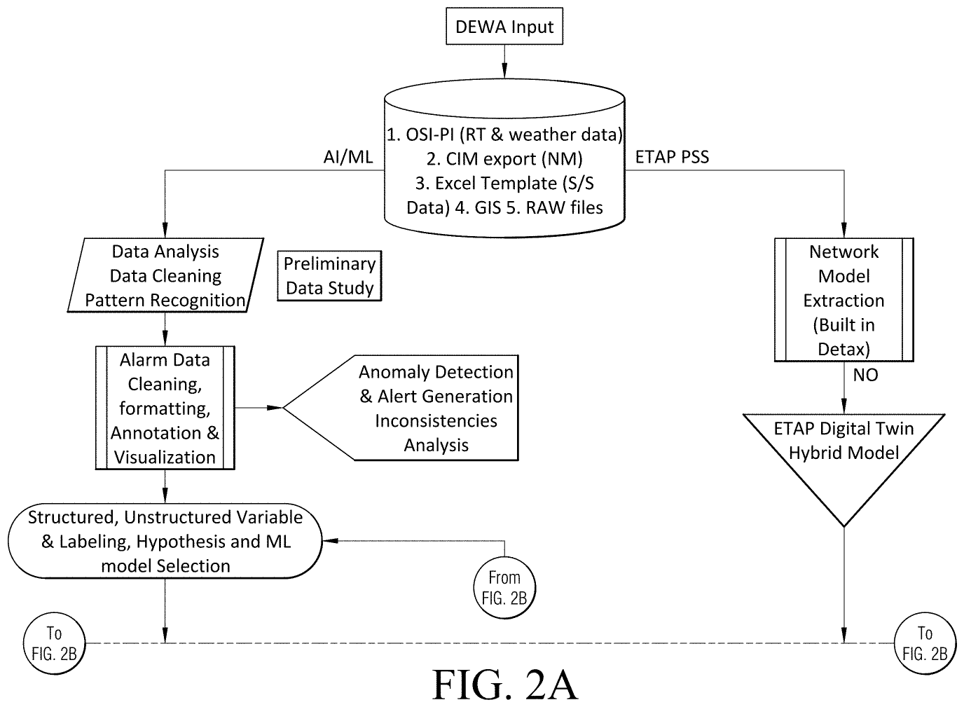

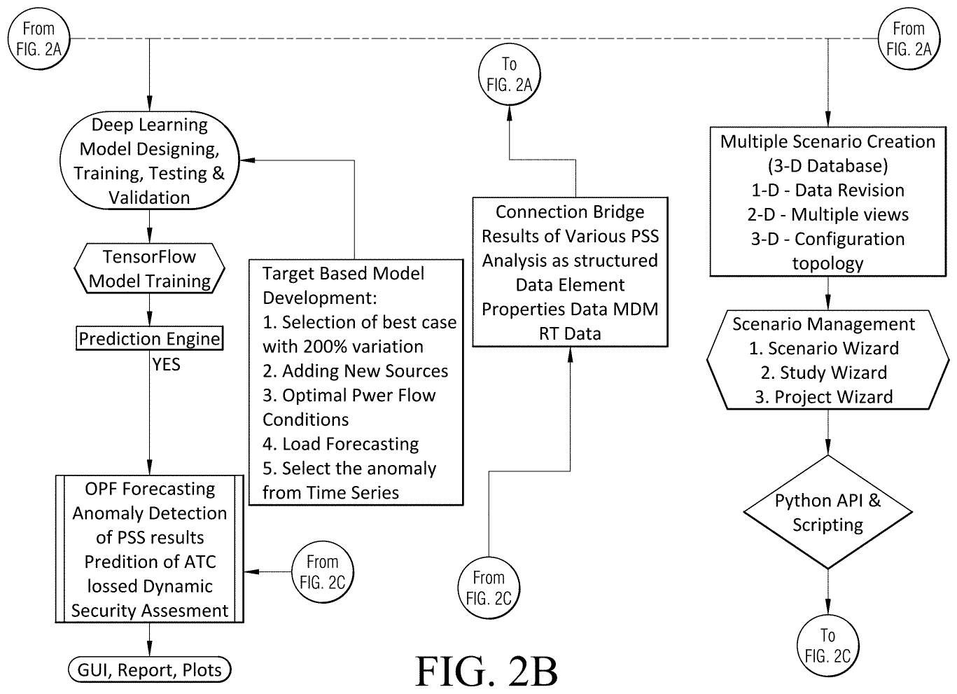

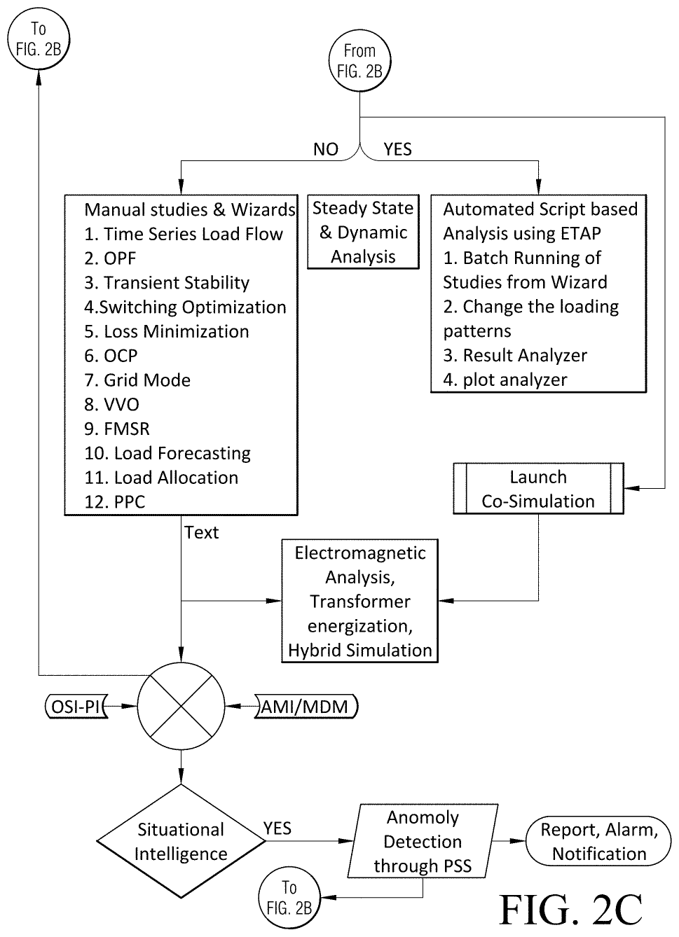

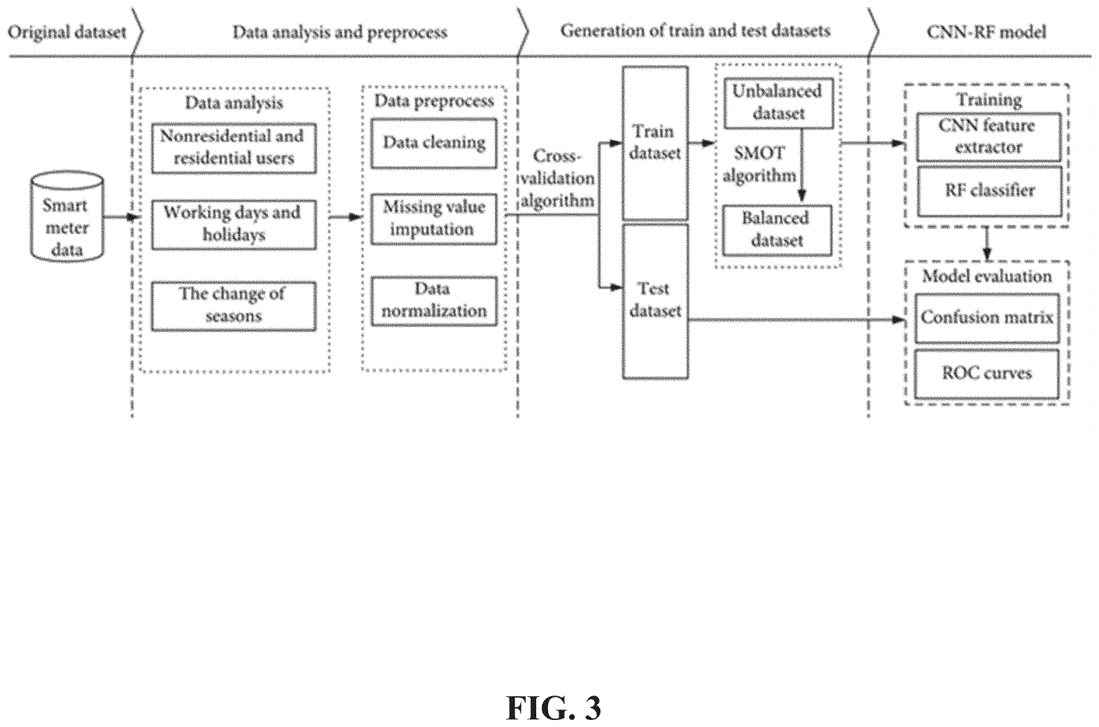

FIG. 2 is a block diagram illustrating a general workflow in accordance with the systems and methods described herein. Several examples use cases are now discussed. The first use case includes electricity loss. FIG. 3 is a block diagram illustrating a use case including electricity loss in accordance with the systems and methods described herein.

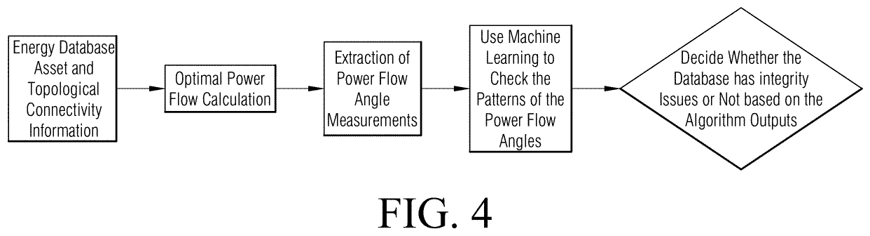

FIG. 4 is a block diagram illustrating a use case of intrusion detection, e.g., using a power grid database, in accordance with the systems and methods described herein. Attack detection in power system database requires close to real-time operation. Hence, we provide an efficient detection architecture where intrusions are not detected directly from the database; rather, it uses a detection mechanism that involves database and determines the existence of intrusions, as discussed elaborately in the following section.

The optimal power flow (OPF) module is a vital module that is used in the energy management system of a power system operation center for decision making purposes. This operational module needs the information of power system conductivity and component parameter information to make its decisions. Therefore, any change or modification in the database may impact on the output of the OPF module.

Asset downtime and O&M costs, especially for green energy production, are a well-known revenue drain for energy producers. The IoT, anomaly detection and predictive maintenance triumvirate can change that. Power lines, power stations, and key equipment can be “plugged in” the predictive maintenance system to identify underperforming assets in real-time and predict the remaining machinery lifetime.

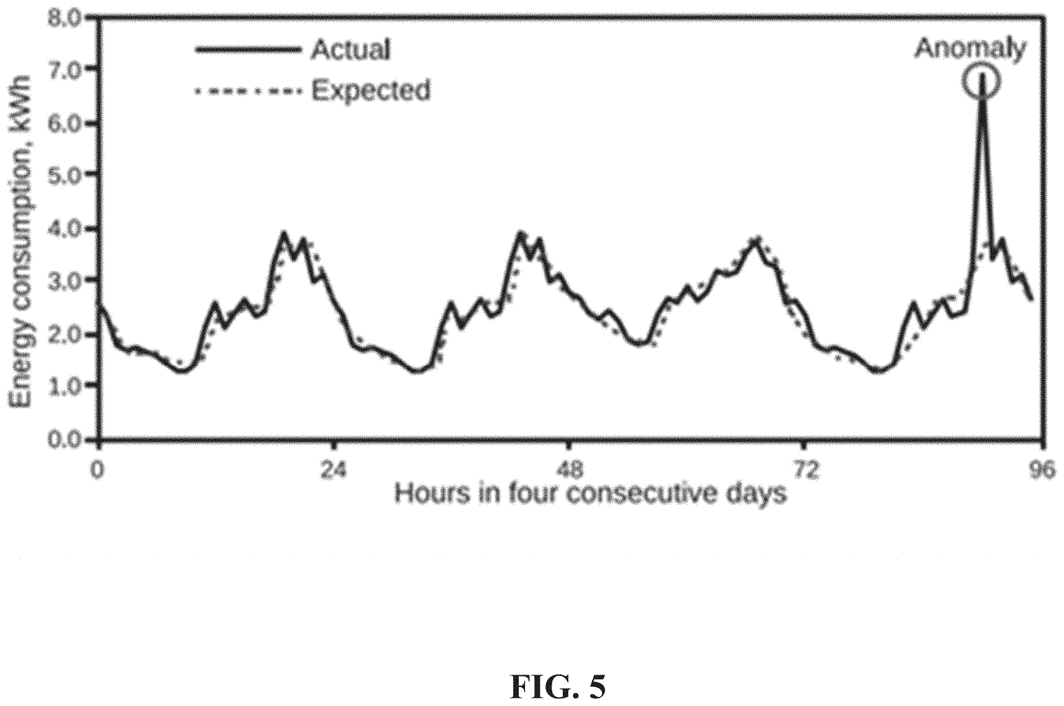

FIG. 5 is a block diagram illustrating a use case including a customer meter anomaly in accordance with the systems and methods described herein. With the widely use of smart meters in the energy sector, anomaly detection becomes a crucial mean to study the unusual consumption behaviors of customers, and to discover unexpected events of using energy promptly. Detecting consumption anomalies is, essentially, a real-time big data analytics problem, which does data mining on a large amount of parallel data streams from smart meters.

Automated Anomaly Detection in Distribution Grids Using μPMU Measurements.

The impact of Phasor Measurement Units (PMUs) for providing situational awareness to transmission system operators has been widely documented. Micro-PMUs (μPMUs) are an emerging sensing technology that can provide similar benefits to Distribution System Operators (DSOs), enabling a level of visibility into the distribution grid that was previously unattainable. In order to support the deployment of these high-resolution sensors, the automation of data analysis and prioritizing communication to the DSO becomes crucial. μPMUs, due to their high sampling frequency, are a much richer data source in comparison to traditional Distribution Supervisory Control and Data Acquisition (DSCADA). The main advantages of this new approach are: (1) The underlying physical model of the data forms the basis in deriving the detection method; providing an interpretation of the event that is lacking in a model free approach. (2) The distribution grid is modeled allowing unbalanced loading and non-transposed lines. The rules are formulated in such a way that allow for distribution grids with neutral wires, and single-phase or two-phase laterals. (3) Quasi steady-state, rather than steady-state, is considered the norm for grid behavior. (4) Part of the proposed methodology only requires the phasor data stream of a single μPMU and is agnostic of the grid interconnection parameters, while the other part correlates the phasor streams across multiple μPMUs using electrical properties of the grid. The detection method applicable to the measurements of a single μPMU is particularly attractive from a security perspective because, assuming that the algorithms are programmed onto the sensor itself, no network communication exchange is needed to obtain results. Therefore, the attacker may have to directly compromise the sensor to alter its response and erase evidence of a physical change.

In some example embodiments, benefits may include one or more of forecasting, result analyzer of various studies, anomaly detection and subset analysis, feeder hosting analysis, running multi-fold studies, load and generation variations, time series analysis and anomaly detection, anticipate and prevent power grid failure, prevent brownouts with real-time monitoring and AI prediction, detect power grid faults, balancing the grid, differentiate power system disturbances from cyber-attacks, and/or detect energy theft.

Some example embodiments may include base case and planning case management. In an example embodiment, a multi-dimensional database eliminates the need to make hundreds of copies of the database. The multi-dimensional database may allow for unlimited graphical presentations, status configurations, base & revision data, and operational parameters within the same project database. Using the concept of Presentation, Status Configuration, and Revision Data, you can create numerous combinations of networks of diverse configurations and varying engineering properties that allow you to fully investigate and study the behavior and characteristics of the electrical networks using one database.

Some example embodiments may have: no need to keep multiple copies of the database. Some example embodiments may eliminate data discrepancies and errors. Some example embodiments may have higher capability and flexibility. Some example embodiments may have higher productivity. Some example embodiments may use less man-hours.

This may imply that you can create multiple year planning cases using one project database, one diagram file and manage the data across multiple engineers, contractors, etc. without losing control over the master model or the base case.

Some example embodiments may include one or more of a orthogonal multi-dimension database, unlimited independent graphical views, unlimited status configurations, unlimited property revisions, multiple loading and generation conditions, real-time operating data, unlimited study solutions, ODBC-SQL server, dumpster with unlimited cells: copy and paste, user access security with password protection, edited-by and checked-by with date stamping, merge project files via clipboard, lock and unlock element properties ten states to track equipment conditions, local SQL server connectivity, utilize real-time operating data, collaborate on projects using Project Merge: License dependent. As used herein “unlimited” may include cases with an arbitrarily large number of items such that the implementation is, for practical purposes, unlimited, e.g., more of the item that is “unlimited” than anyone using the systems and methods herein would use. The actual number may vary depending on the particular item that is “unlimited.” For example, “unlimited property revisions” may be more property revisions than are usually performed, e.g., 10×, 100×, 1000×, or any other arbitrary large number of property revisions.

Similarly, unlimited independent graphical views and unlimited status configurations may include any numbers that are more than will ever be practically used. Generally the items may be limited by memory or other storage limitations.

Scenario Management & Python Scripting

Today's fast evolving power systems require engineers to perform thorough studies for the purpose of evaluating the operation of their networks under different conditions. Although informative, some of these studies can be repetitive and time-consuming. Automation relieves engineers from redundant and laborious procedures, and effortlessly provides the required information and results.

In some embodiments, the Wizards may comprise a Scenario Wizard, a Study Wizard, and a Project Wizard, which are described below in detail.

Scenario Wizard

Every project file contains a Scenario Wizard. Scenarios are created and recorded in the Scenario Wizard and can be run individually at any time. A project may have an unlimited number of scenarios. Scenarios are composed of the following parameters: (1) Presentation (one-line diagram, underground systems, control systems diagram) Configuration (2) Data revision (base or revision data) (3) Analysis type (load flow, short circuit) (4) Study type (line-to-ground fault, dynamic motor acceleration, frequency scan) (5) Study case (solution parameters such as loading categories, generation categories, diversity factors, alert settings) (6) Output report name (7) When a scenario is executed in a project, it may automatically create an output report or overwrite the existing report of the same name.

Study Wizard

Every project file also contains a Study Wizard. The Study Wizard enables you to sequentially group existing scenarios into Study Macros. A project may have an unlimited number of Study Macros. Running the defined Study Macro may run all of the scenarios associated with it and create or overwrite the output reports similarly to that of the Scenario Wizard. For example, you could group scenarios related to Load Flow or a specific type of Load Flow into one Study Macro.

Project Wizard

The Project Wizard enables the user to group existing Study Macros into Project Macros. The Project Wizard allows running Project Macros for one or multiple project files. This feature automates opening and closing project files and individually executing Study Macros and scenarios.

Python Scripting

Python is a scripting language that is open-source and cross-platform. Unlike other programming languages, Python does not have difficult syntax and offers code completion. Its high readability combined with software function names makes Python easy to learn for beginners while staying powerful for experts.

Aiming to ease the effort required in performing several simulations by hand and to extend the customization of software, Python scripting has been integrated into the power system analysis software. With Python scripting, users can easily perform batch analysis, automate routine studies, create new analysis reports, and quickly retrieve information and display in custom reports through a simple mouse-click on a script.

Users can avoid writing complex python scripts by simply utilizing built-in scenario, study and project wizards that utilize behind the scenes XML information to store and execute studies in a batch. Project macros to run multiple study scenarios with a single-click and generate multiple reports instead of running each individually, saving valuable time and effort. Not only does it take care of exception handling, the Scripting Tool with Python has also been robustly designed to provide the latest data model. Scripting Tool utilizes any beginner or professional IDE like Visual Studio for code/script execution. Python scripting takes advantage of all the power accessible through regular expressions, along with an advanced filtering mode that helps when accessing data collection.

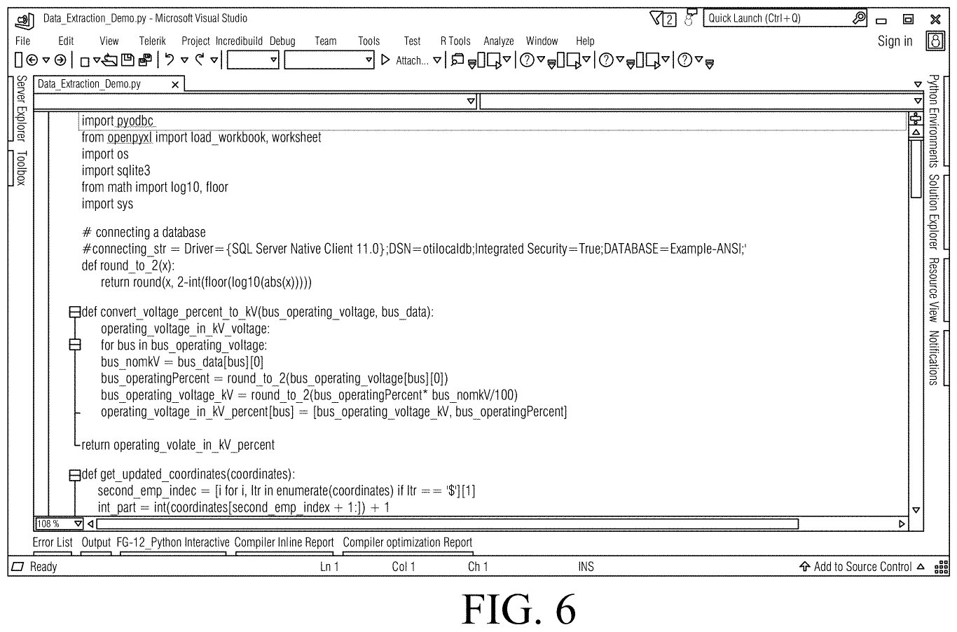

FIG. 6 is a diagram illustrating a scripting example in accordance with the systems and methods described herein.

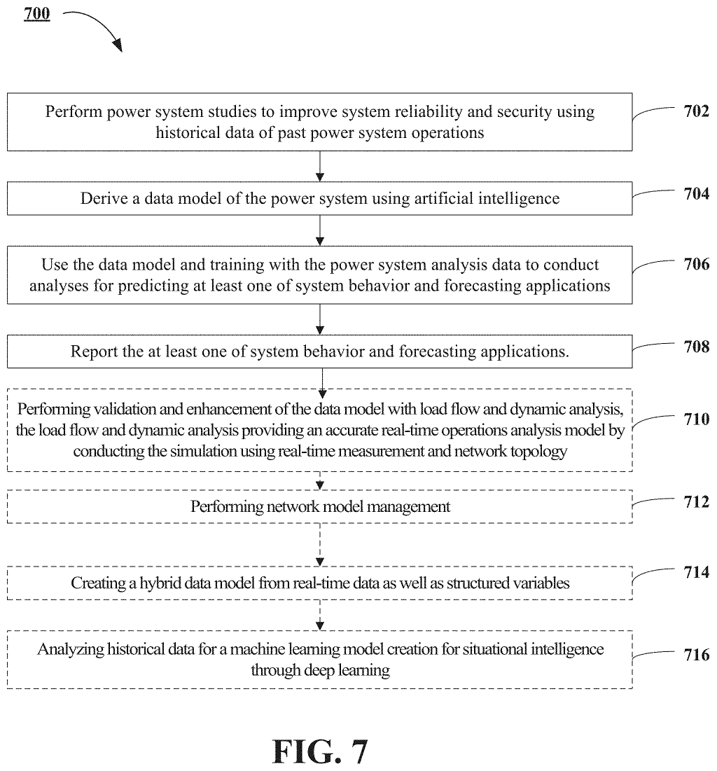

FIG. 7 is a flow diagram illustrating an example method 700 in accordance with the systems and methods described herein. The method 700 may be a method for analyzing an electrical network. The method includes performing power system studies to improve system reliability and security using historical data of past power system operations (702); deriving a data model of the power system using artificial intelligence (704); using the data model and training with the power system analysis data to conduct analyses for predicting at least one of system behavior and forecasting applications (706); and reporting the at least one of system behavior and forecasting applications (708).

Optionally, the method 700 may include one or more of performing validation and enhancement of the data model with load flow and dynamic analysis, the load flow and dynamic analysis providing an accurate real-time operations analysis model by conducting the simulation using real-time measurement and network topology (710); performing network model management (712); creating a hybrid data model from real-time data as well as structured variables (714); and analyzing historical data for a machine learning model creation for situational intelligence through deep learning (716).

Performing power system studies to improve system reliability and security using historical data of past power system operations (702) may include analyzing the historical data and generating predictions related to the reliability and security of a power system based on the analysis.

Deriving a data model of the power system using artificial intelligence (704) may include taking the historical data and/or other available data about the power system and applying the data to an artificial intelligence (AI) to deriving a data model of the power system.

Using the data model and training with the power system analysis data to conduct analyses for predicting at least one of system behavior and forecasting applications (706) include receiving the data model and applying the data model to predict at least one of system behavior and forecasting applications.

Reporting the at least one of system behavior and forecasting applications (708) includes generating the at least one of system behavior, receiving the at least one of system behavior, and reporting the at least one of system behavior to a user.

Performing validation and enhancement of the data model with load flow and dynamic analysis, the load flow and dynamic analysis providing an accurate real-time operations analysis model by conducting the simulation using real-time measurement and network topology (710) fetching data model and performing validation and enhancement of the data with load flow and dynamic analysis. Performing network model management (712) include fetching the network model and administering the information fetched.

Creating a hybrid data model from real-time data as well as structured variables (714) may include receiving the real-time data as well as structured variables and generating the hybrid data from the data received. Analyzing historical data for a machine learning model creation for situational intelligence through deep learning (716) fetching the historical data and applying the historical data to a machine learning model.

The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A system for analyzing an electrical network, comprising:
a memory; and
a processor, coupled to the memory, the processor configured to execute instructions from the memory causing the processor to:
perform power system studies to improve system reliability and security using historical data of past power system operations,
derive a data model of the power system using artificial intelligence,
use the data model and training with the power system analysis data to conduct analyses for predicting at least one of system behavior and forecasting applications, and
report the at least one of system behavior and forecasting applications.

2. The system of claim 1, wherein the data model comprises a centralized model that represents a digital twin model of the electrical network.

3. The system of claim 1, further comprising instructions to perform validation and enhancement of the data model with load flow and dynamic analysis, the load flow and dynamic analysis providing an accurate real-time operations analysis model by conducting the simulation using real-time measurement and network topology.

4. The system of claim 1, further comprising instructions to perform network model management.

5. The system of claim 1, wherein the network model management comprises addition, deletion, change model updating.

6. The system of claim 1, further comprising instructions to create a hybrid data model from real-time data as well as structured variables.

7. The system of claim 1, wherein artificial intelligence provides at least one of data anomaly and pattern detection, or analyzing power system simulation results as well as conducting deep model development.

8. The system of claim 7, wherein the data anomaly and pattern detection provide a data anomaly.

9. The system of claim 7, wherein analyzing power system simulation results as well as conducting the deep model development to conduct varieties of analysis by changing the loading and generation pattern for multiple scenarios and cases.

10. The system of claim 1, further comprising instructions to analyze historical data for a machine learning model creation for situational intelligence through deep learning.

11. A method for analyzing an electrical network, the method comprising:
performing power system studies to improve system reliability and security using historical data of past power system operations;
deriving a data model of the power system using artificial intelligence;
using the data model and training with the power system analysis data to conduct analyses for predicting at least one of system behavior and forecasting applications; and
reporting the at least one of system behavior and forecasting applications.

12. The method of claim 11, wherein the data model comprises a centralized model that represents a digital twin model of the electrical network.

13. The method of claim 11, further comprising performing validation and enhancement of the data model with load flow and dynamic analysis, the load flow and dynamic analysis providing an accurate real-time operations analysis model by conducting the simulation using real-time measurement and network topology.

14. The method of claim 11, further comprising performing network model management.

15. The method of claim 11, wherein the network model management comprises addition, deletion, change model updating.

16. The method of claim 11, further comprising creating a hybrid data model from real-time data as well as structured variables.

17. The method of claim 11, wherein artificial intelligence provides at least one of data anomaly and pattern detection or analyzing power method simulation results as well as conducting deep model development.

18. The method of claim 17, wherein the data anomaly and pattern detection provide a data anomaly.

19. The method of claim 17, wherein analyzing power method simulation results as well as conducting the deep model development to conduct varieties of analysis by changing the loading and generation pattern for multiple scenarios and cases.

20. The method of claim 11, further comprising analyzing historical data for a machine learning model creation for situational intelligence through deep learning.
